(19) United States
(12) Patent Application Publication
(10) Pub. No.: US 2016/0091052 A1
(43) Pub. Date: Mar. 31, 2016

(54) ACTUATOR AND ELECTRONIC EQUIPMENT HAVING THE SAME

(71) Applicant: MOATECH CO., LTD., Incheon (KR)

(72) Inventors: In-Yong PARK, Incheon (KR); Yun CHOI, Incheon (KR); Seong-Gi PARK, Incheon (KR)

(21) Appl. No.: 14/863,483

(22) Filed: Sep. 24, 2015

(30) Foreign Application Priority Data
Sep. 25, 2014 (KR) 10-2014-0128580
Sep. 10, 2015 (KR) 10-2015-0128389

(51) Int. Cl. F16H 1/20

(52) U.S. Cl. CPC F16H 1/203

(57) ABSTRACT

Provided herein is an actuator including a housing unit, a drive unit installed in the housing unit, the drive unit having a rotating shaft, a plurality of gears installed in the housing unit and rotated by rotational power of the shaft, the gears being engaged with each other, and a reinforcement part installed in an inside portion of one of the plurality of gears to create reinforcing force. Also, provided herein is an electronic apparatus having the actuator.

### CROSS-REFERENCE TO RELATED APPLICATIONS

This application claims the benefit of Korean Patent Application No. 10-2014-0128580 filed on Sep. 25, 2014, and KR Patent Application No. 10-2015-0128389 filed on Sep. 10, 2015, which are hereby incorporated by reference in their entirety into this application.

### BACKGROUND OF THE INVENTION

1. Field of the Invention

The present invention relates to an actuator and, more particularly, to an actuator capable of preventing generation of an error in actuating angle by preventing declination in the injection and molding operation and an electronic apparatus having the same.

2. Description of the Related Art

Various kinds of vehicles including automobiles and trucks are generally equipped with headlamps at the front thereof. The headlamps are turned on to ensure safe driving when a clear view is not secured at night or in a bad weather.

Conventionally, a headlamp is separately provided with a high beam lamp and a low beam lamp. Thereby, the low beam lamp is usually tuned on during driving. The high beam lamp is turned on when the front view is particularly unclear.

Accordingly, vertical rotation positions of a vehicular headlamp are set and controlled by operation of a separate actuator.

In addition, the lamp assembly is connected to a shaft rotatably provided to the actuator, and the rotation position thereof is determined in connection with rotation of the shaft.

Herein, the rotational power of the shaft is transmitted to multiple gears engaged with each other.

The gears configured as above are generally fabricated through injection molding.

When a gear fabricated through injection molding is left in a high-temperature atmosphere, the gear becomes eccentric in the curvature direction and thus comes to have a cumulative pitch error. Thereby, precision of the gear is lowered.

In addition, when gears having eccentric errors rotate by being engaged with each other, an operating angle error is produced.

A prior art document related to the present invention is Korean Utility Application Publication No. 20-1999-0015589 (Publication date: May 15, 1999).

### SUMMARY OF THE INVENTION

In view of the above, an object of the present invention is to provide an actuator capable of minimizing deviation of the operating angle by preventing deviation of a gear in injection molding and thermal deformation of the gear in a high-temperature atmosphere and an electronic apparatus having the same.

Another object of the present invention is to provide an actuator capable of enhancing durability of gears and an electronic apparatus having the same.

Another object of the present invention is to provide an actuator capable of stably supporting a bearing member for guiding rotation of a rotation shaft of a gear and an electronic apparatus having the same.

According to an aspect of the present, there is provided an actuator including a housing unit, a drive unit installed in the housing unit, the drive unit having a rotating shaft, a plurality of gears installed in the housing unit and rotated by rotational power of the shaft, the gears being engaged with each other, and a reinforcement part installed in an inside portion of one of the plurality of gears to create reinforcing force.

Preferably, the plurality of gears includes a first gear connected to the shaft arranged along a first axis and configured to rotate, a second gear configured to rotate about a second axis perpendicular to the first axis in connection with the first gear, and a third gear configured to rotate about a third axis perpendicular to the second axis in connection with the second gear,

Preferably, the second gear is a multi-step gear formed stepwise.

Preferably, the reinforcement part is inserted into an inside of a lower end of the multi-step gear.

Preferably, the second gear includes an upper gear and a lower gear, the lower gear being formed at a lower end of the upper gear and having a greater diameter than the upper gear.

An installation hole is formed at a center of the lower gear.

The reinforcement part may be fixedly inserted into the installation hole.

It is better for the reinforcement part to be a reinforcement member made of a metallic material and formed in a ring shape.

The reinforcement part may be a reinforcement member having two steps.

The reinforcement part may be a reinforcement member having multiple steps.

Preferably, a height of the reinforcement part is covered by a length of the rotation shaft penetrating the gears to rotatably support the gears.

It is better for the reinforcement part to closely contact an outer surface of the rotation shaft.

Preferably, one region of the reinforcement part is positioned on an axis perpendicular to an axial line of rotation of a counterpart gear part engaged with the reinforcement part. Preferably, a thickness of the reinforcement member in a direction of centripetal force is greater than a thickness of the lower gear.

Preferably, the reinforcement member is one of a ball bearing and a sleeve bearing.

Preferably, the reinforcement part is installed at the plurality of gears through one of press fitting, welding, caulking and injection molding.

One end of the first gear is provided with a bearing,

Preferably, the housing unit is provided with a bearing accommodation portion, the bearing being accommodated in the bearing accommodation portion.

Preferably, a bearing cover for covering the bearing is detachably installed at the bearing accommodation portion.

According to another aspect of the present invention, there is provided an electronic apparatus including the actuator.

According to embodiments of the present invention, operating angle deviation may be minimized by preventing deviation of a gear in fabricating the gear through injection molding and thermal deformation of the gear in a high-temperature atmosphere.

According to embodiments of the present invention, durability of gears may be enhanced.

According to embodiments of the present invention, a bearing member for guiding rotation of a rotation shaft of a gear may be stably supported.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating an actuator according to an embodiment of the present invention;

FIG. 2 is an exploded perspective view illustrating the actuator according to an embodiment of the present invention;

FIG. 3 is a perspective view illustrating arrangement of a plurality of gears according to an embodiment of the present invention;

FIG. 4 is a perspective view illustrating a second gear and a reinforcement part according to an embodiment of the present invention;

FIG. 5 is a perspective view illustrating a reinforcement part according to another embodiment of the present invention;

FIG. 6 is a cross-sectional view illustrating coupling of the reinforcement part and the second gear shown in FIG. 5;

FIG. 7 is a perspective view illustrating a reinforcement part according to another embodiment of the present invention;

FIG. 8 is an exploded perspective view illustrating coupling of the reinforcement part and the second gear shown in FIG. 7;

FIG. 9 is a cross-sectional view illustrating coupling of the reinforcement part and the second gear shown in FIG. 7;

FIG. 10 is a view illustrating connection between the first gear and the second gear;

FIG. 11 is a view illustrating engagement of the second gear with the third gear;

FIG. 12 is a perspective view illustrating installation of a bearing cover according to an embodiment of the present invention; and

FIG. 13 is a graph depicting angular variation of the second gear when a reinforcement member is not applied and when the reinforcement member is applied.

### DETAILED DESCRIPTION OF THE PREFERRED EMBODIMENT

Hereinafter, an actuator according to an embodiment of the present invention will be described in detail with reference to the accompanying drawings.

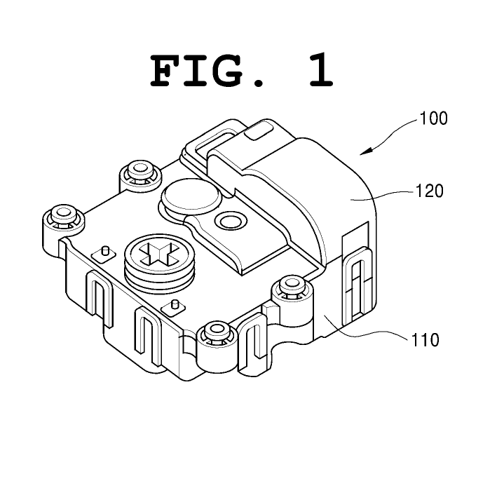

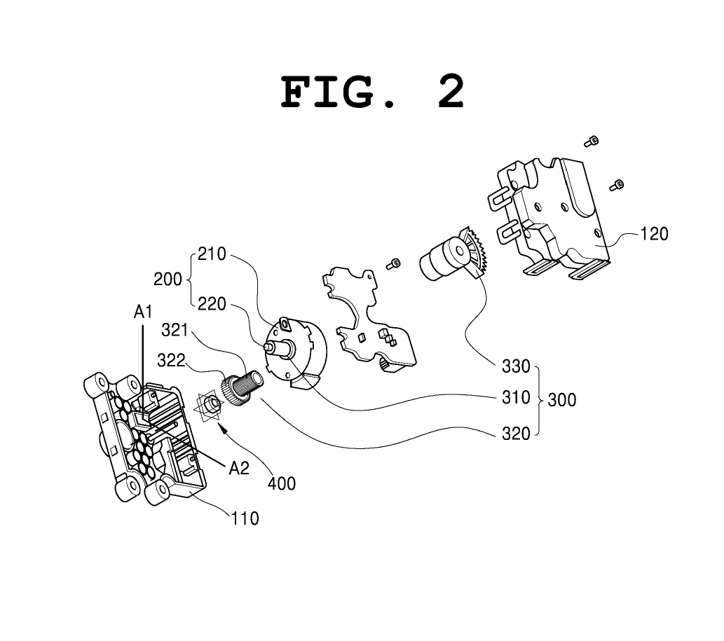

FIG. 1 is a perspective view illustrating an actuator according to an embodiment of the present invention, and FIG. 2 is an exploded perspective view illustrating the actuator according to an embodiment of the present invention.

Referring to FIGS. 1 and 2, the actuator includes a housing unit 100, a drive unit 200, a plurality of gears 300, and a reinforcement part 400.

Housing Unit 100

The housing unit 100 includes a lower housing 110 and an upper housing 120, which is coupled to the upper end of the lower housing 110.

Drive Unit 200

The drive unit 200 includes a motor 210 and a shaft 220.

The shaft 220 is arranged on the central axis of the motor 210 and rotation thereof is actuated by driving the motor 210.

Herein, the shaft 220 rotates about a first axis \textcircled{1} extending in a horizontal direction.

Plurality of Gears 300

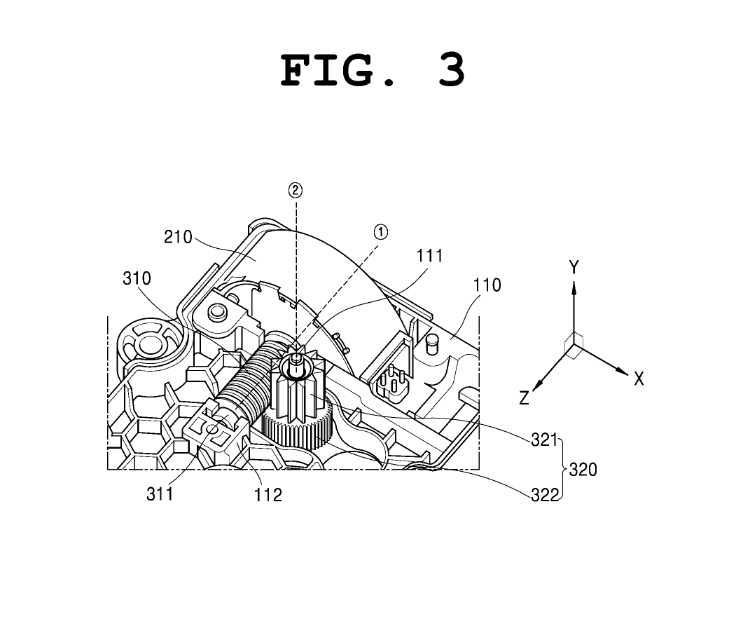

FIG. 3 is a perspective view illustrating arrangement of a plurality of gears according to an embodiment of the present invention.

Referring to FIG. 3, the plurality of gears 300 includes a first gear 310, a second gear 320 and a third gear 330.

The first gear 310 is installed on the shaft 220 and rotated according to rotation of the shaft 220.

Accordingly, the first gear 310 rotates about the first axis \textcircled{1}.

Herein, a first installation area A1 where the drive unit 200 and the first gear 310 are seated is defined in the lower housing 110.

The second gear 320 is vertically disposed to be engaged with the first gear 310.

A second installation area A2 where the second gear 320 is installed is defined in the lower housing 110. A rotation shaft 111 arranged on a second axis \textcircled{2} perpendicular to the first axis (\textcircled{1}) is disposed in the second installation area A2.

The second gear 320 is fitted onto the rotation shaft 111 and rotatably disposed.

In addition, the second gear 320 rotates in connection with the first gear 310.

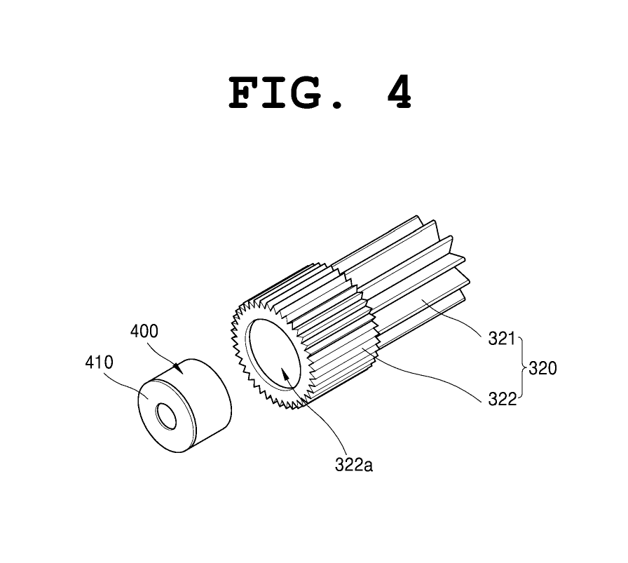

FIG. 4 is a perspective view illustrating a second gear and a reinforcement part according to an embodiment of the present invention FIG. 4.

Hereinafter, the second gear 320 according to an embodiment will be described with reference to FIG. 4.

The second gear 320 includes a stepped multi-step gear.

The second gear 320 includes an upper gear 321 and a lower gear 322 formed at the lower end of the upper gear 321.

Preferably, the diameter of the lower gear 322 is greater than that of the upper gear 321.

In addition, an installation hole 322a is formed at the inner center of the lower end of the lower gear 322.

Meanwhile, the third gear 330 is installed to the lower housing 110 such that the third gear 330 is engaged with the upper gear 321 of the second gear 320.

Accordingly, the third gear 330 may be rotated in connection with rotation of the second gear 320 and cause other external structures such as a headlamp for a vehicle to rotate within a certain range of angle of rotation in a reciprocating manner.

Reinforcement Part 400

Referring to FIGS. 2 and 3, the reinforcement part 400 is installed at the inner center of the second gear 320.

The reinforcement part 400 includes a ring-shaped reinforcement member 410.

Preferably, the reinforcement member 410 is formed of a metallic material.

The reinforcement member 410 may be installed at the inner center of the second gear 320 through one of press-fit, welding, caulking and insert molding.

Preferably, the reinforcement member 410 is press-fit into the installation hole 322a formed in the lower gear 322 of the second gear 320.

Preferably, the thickness of the reinforcement member 410 in the direction of centripetal force is greater than that of the lower gear 322 of the second gear 320.

Substantially, the outer circumference of the reinforcement member 410 serves to closely contact the inner circumference of the lower gear 322 of the second gear 320 defining the installation hole 322a to support the lower gear 322.

The reinforcement member 410 may include either a ball bearing or a sleeve bearing.

Although not shown in the figure, radially protruding projections may be formed on the outer circumference of the reinforcement member 410.

Herein, multiple projection grooves into which the projections are fixedly fitted are preferably formed on the inner circumference of the lower gear 322 defining the installation hole 322a.

Accordingly, when the reinforcement member 410 is inserted into the installation hole 322a, the projections may be fitted into the projection grooves, thereby securing additional fixing force.

Additionally, the projections may have a curve shape, and the projection grooves may have a curve shape.

Thereby, even if the lower gear 322 is thermally deformed by contracting and expanding according to the external temperature atmosphere, deforming force according to contraction and expansion maybe deconcentrated through contact between the curved surfaces. Thereby, the amount of deformation of the second gear 320 may be minimized.

As the reinforcement member, which is a component for compensating for deformation of the injection-molded gear is inserted into the second gear to support the second gear through the configuration and operation described above, precision of the gear may be enhanced.

Thereby, an improvement related to gear engagement deviation may be obtained, and thus an improvement may be achieved in relation to deviation of operating angle errors affecting the product performance.

In addition, when the gear is left in a high-temperature environment, thermal deformation may be prevented as the reinforcement member is formed of a metallic material and supports the gear at the inner-diameter portion of the gear. Thereby, degradation of gear precision may be prevented.

Next, another example of the reinforcement part of the present invention will be described.

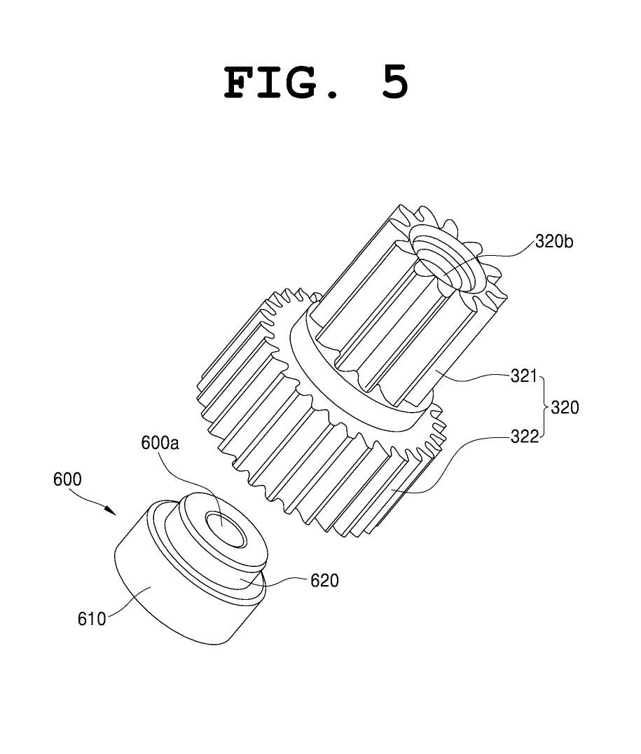

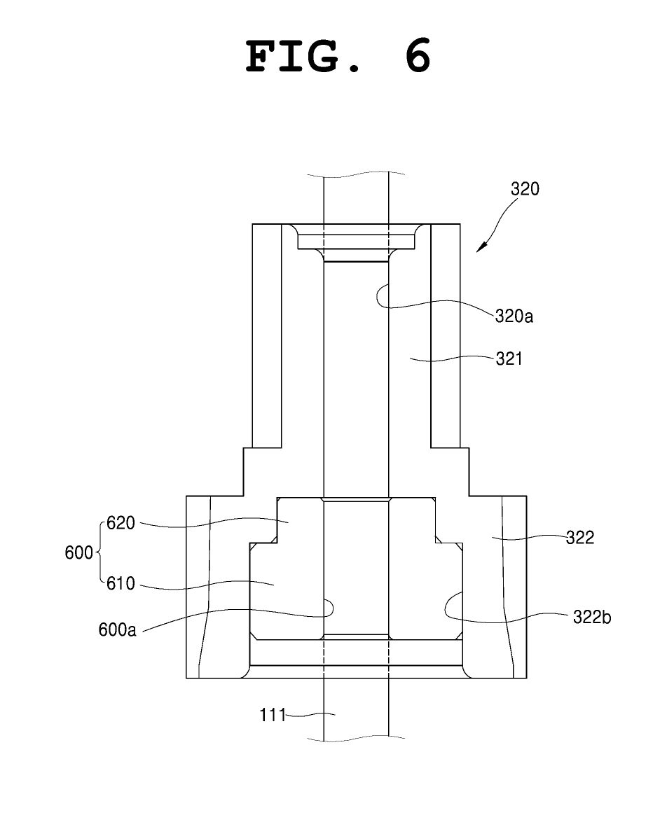

FIG. 5 is a perspective view illustrating a reinforcement part according to another embodiment of the present invention, and FIG. 6 is a cross-sectional view illustrating coupling of the reinforcement part and the second gear shown in FIG. 5.

Referring to FIG. 5, a reinforcement part 600 includes reinforcement members 610 and 620, which form two steps.

The two-step reinforcement members 610 and 620 are formed in a stepped ring shape.

Herein, the second gear 320 is provided with a rotation hole 320a, through which the rotation shaft 111 passes. The lower end of the second gear 320 is provided with an two-step-shaped installation hole 322b, into which the reinforcement part 600 is press-fit.

The reinforcement part 600 is provided with a through hole 600a, through which the rotation shaft 111 is passed.

The reinforcement part 600 is installed by being press-fit into the installation hole 322b of the second gear 320.

The rotation shaft 111 passed through the through hole 600a of the reinforcement part 600 may closely contact the inner surface of the through hole 600a.

As the length of the reinforcement part 600 press-fit into the second gear 320, which is an injection-molded gear, increases, clearance of the rotation shaft 111 supporting the second gear 320 is minimized.

Thereby, movement of the rotation shaft 111 is prevented, and thus the operating angle error resulting from shaking of the gear is lowered.

Next, a reinforcement part according to another embodiment of the present invention will be described.

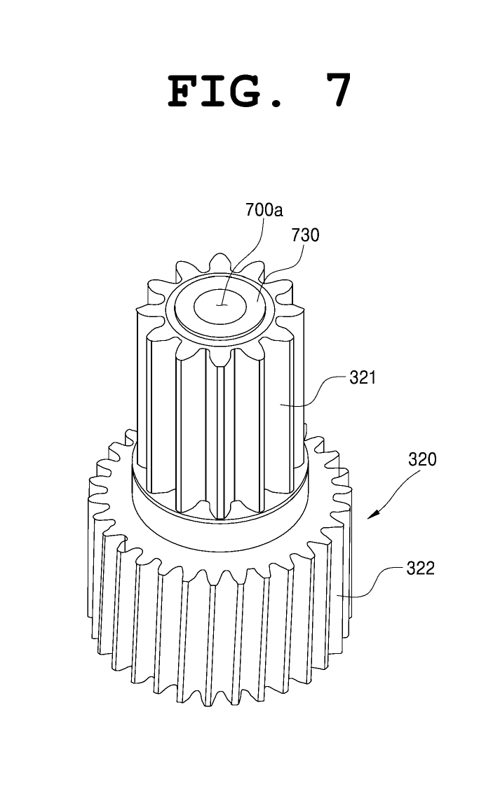

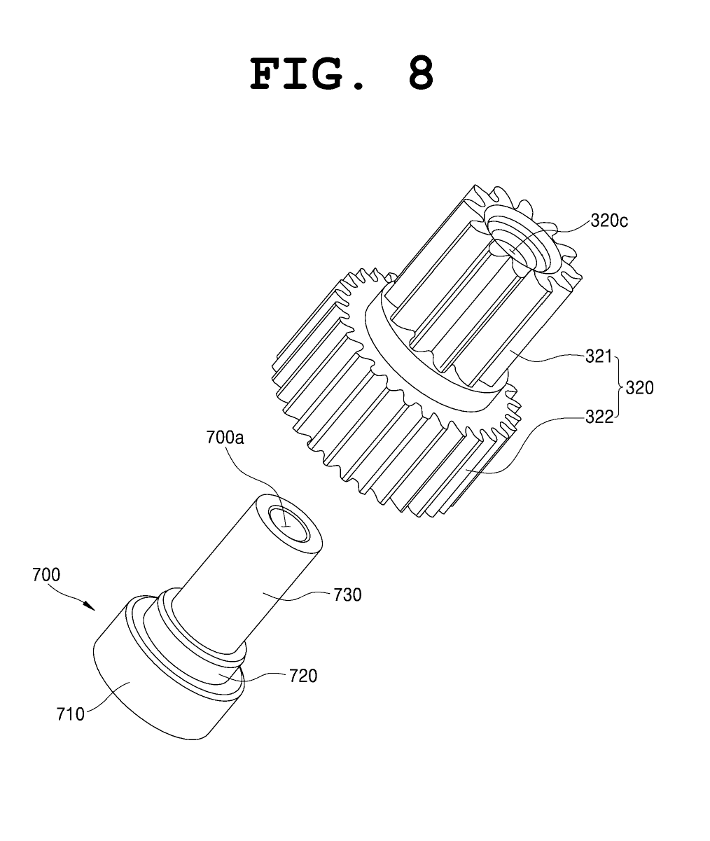

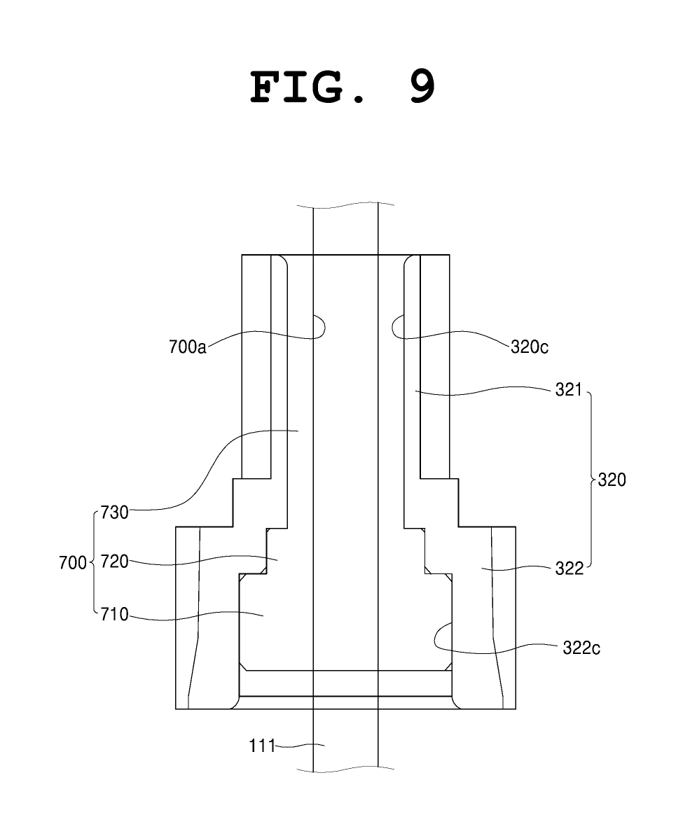

FIG. 7 is a perspective view illustrating a reinforcement part according to another embodiment of the present invention, FIG. 8 is an exploded perspective view illustrating coupling of the reinforcement part and the second gear shown in FIG. 7, and FIG. 9 is a cross-sectional view illustrating coupling of the reinforcement part and the second gear shown in FIG. 7.

Referring to FIGS. 7 and 9, a reinforcement part 700 includes reinforcement members 710, 720 and 730, which form multiple steps.

The reinforcement members 710, 720 and 730 forming three steps are formed in a stepped ring shape.

Herein, the second gear 320 is provided with the rotation hole 320a. The lower end of the second gear 320 is provided with an installation hole 322c with a three-step shape, into which the reinforcement part 700 is press-fit.

Among the reinforcement members 710, 720 and 730 forming three steps, the uppermost reinforcement member 730 is positioned in the rotation hole 320a of the second gear 320, and closely contacts the inner surface of the rotation hole 320a.

The reinforcement part 700 is provided with a through hole 700a, into which the rotation shaft 111 is fitted.

The reinforcement part 700 is installed by being press-fit into the installation hole 320c of the second gear 320.

The rotation shaft 111 passing through the through hole 700a of the reinforcement part 700 may closely contact the inner surface of the through hole 700a.

According to this configuration, the reinforcement part 700 is formed in a three-step shape and is press-fit into the rotation hole 320a and the installation hole 322c formed in the second gear 320.

Additionally, the height of the reinforcement part 700 is covered by the length of the rotation shaft 111, which is passed through the reinforcement part 700 to rotatably support the second gear 320.

Accordingly, the reinforcement part 700 may closely contact the outer surface of the rotation shaft 111.

That is, the reinforcement parts 600 and 700 may have a height by which the reinforcement part 600 and 700 can closely contact apart or the entirety of the outer surface of the rotation shaft 111.

Accordingly, as the length of the reinforcement part press-fit into the second gear 320, which is an injection-molded gear, increases, clearance of the rotation shaft 111 supporting the second gear 320 may be minimized.

Thereby, movement of the rotation shaft 111 is prevented, and thus the operating angle error resulting from shaking of the second gear 320 may be lowered.

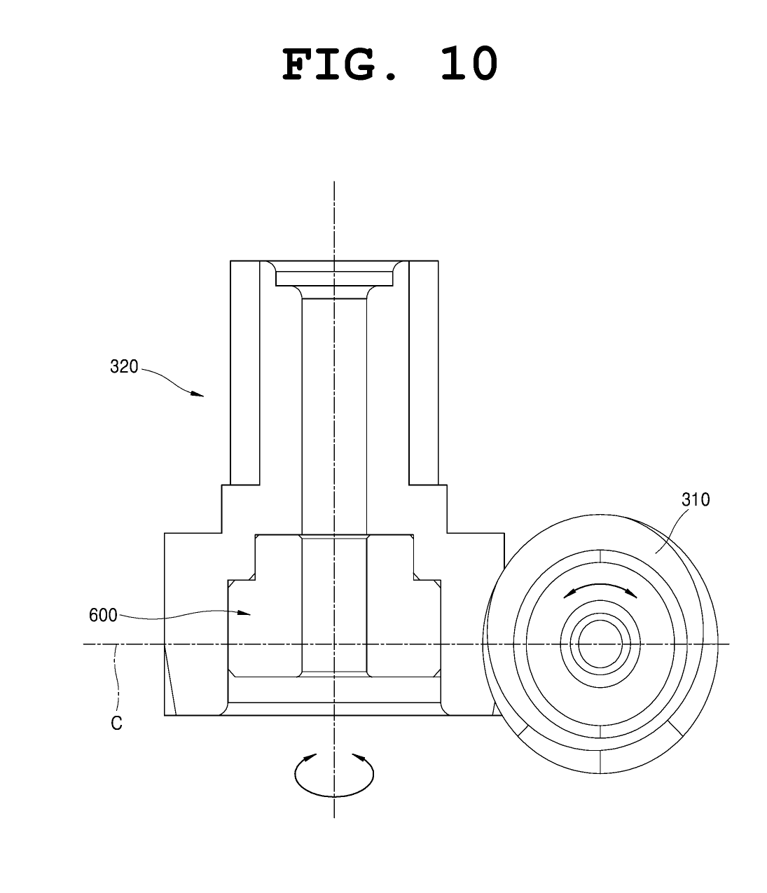

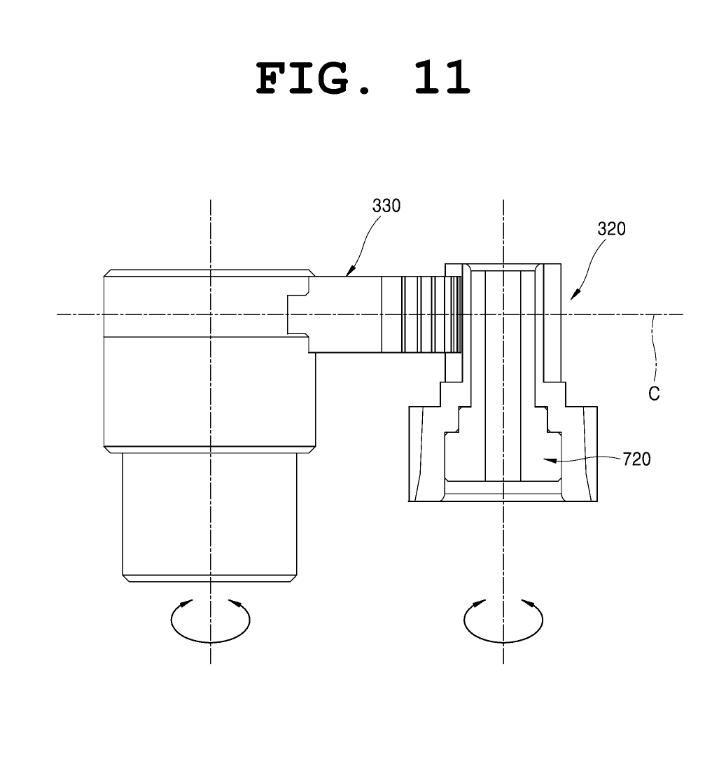

FIG. 10 is a view illustrating connection between a first gear and a second gear, and FIG. 11 is a view illustrating engagement of the second gear with the third gear.

Referring to FIGS. 10 and 11, a portion of the area of the reinforcement part 600, 700 may be positioned on axis C which is perpendicular to the rotation axis of the counterpart gear engaged with the reinforcement part 600, 700.

FIG. 10 illustrates a case where a portion of the area of the reinforcement part 600 installed on the second gear 320 is on the axial line C of the first gear 310.

FIG. 11 illustrates a case where a portion of the area of the reinforcement part 700 installed on the second gear 320 is on the axial line C of the third gear 330.

Accordingly, deformation of the second gear 320 may be prevented by disposing the reinforcement part 700 such that the reinforcement part 700 is arranged at a position corresponding to the axial line C of the first gear 310 or the third gear 330, which is a counterpart gear engaged with the reinforcement part.

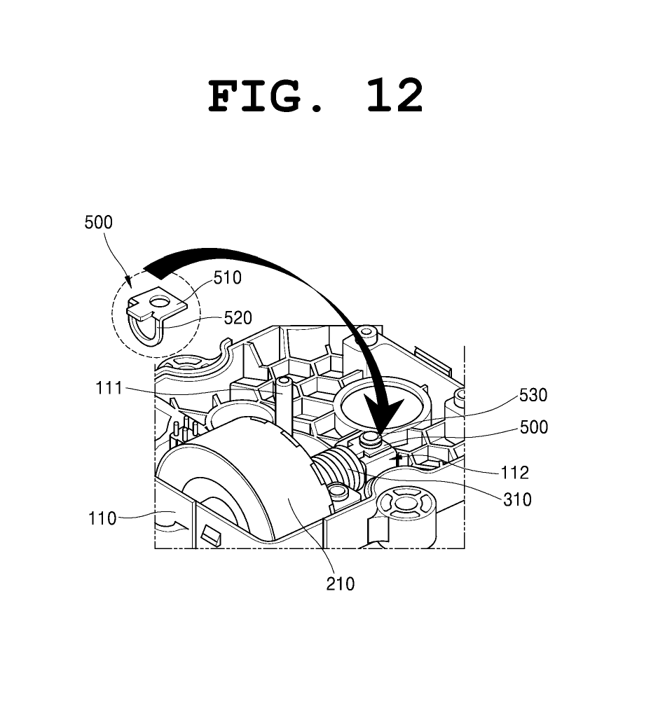

FIG. 12 is a perspective view illustrating installation of a bearing cover according to an embodiment of the present invention.

The lower housing 110 may be further provided with a bearing accommodation portion 112.

Referring to FIG. 12, a bearing 311 is installed at an end of the first gear 310.

The bearing accommodation portion 112, which is formed by partitions to define an inner space therein, is formed in the first installation area A1 in the lower housing 110.

The bearing 311 of the first gear 310 is positioned in the inner space of the bearing accommodation portion 112.

In addition, a bearing cover 500 is installed at the upper end of the bearing accommodation portion 112.

The bearing cover 500 may not only cover the bearing 311 to prevent the bearing 311 from being displaced from the position, but also fix the bearing 311 at the installation position.

Herein, the bearing cover 500 may be detachable from the upper end of the bearing accommodation portion 112.

The bearing cover 500 includes a cover body 510, which is disposed at the upper end of the bearing accommodation portion 112 and covers the inner space of the bearing accommodation portion 112, and a catch ring 520, which is bent downward from a lateral portion of the cover body 510.

The catch ring 520 is caught by a catch protrusion (not shown) formed on the outer surface of the partition of the bearing accommodation portion 112.

In addition, the cover body 510 may be fixed by being screw-coupled to the bearing accommodation portion 112 by a screw bolt 530.

According to an embodiment of the present invention, by covering the bearing installed at an end of the first gear and fixing the installation position of the bearing, stable gear operation may be guided.

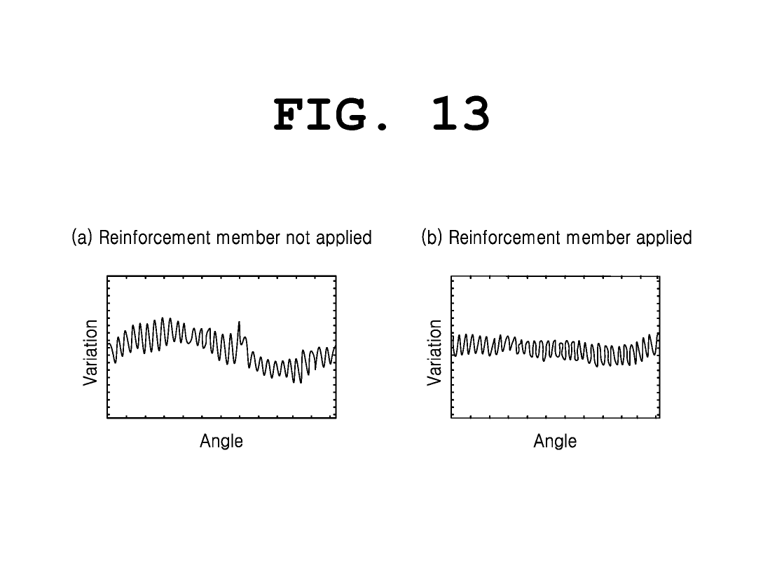

FIG. 13 is a graph depicting angular variation of the second gear when a reinforcement member is not applied and when the reinforcement member is applied.

FIG. 13 shows the results of vibration according to the rotation angle of the second gear (a) when the reinforcement member is not applied and (b) when the reimbursement member is applied. In case (a), the angular variation changes. In case (b), the angular variation is constant.

That is, graph (a) implies that the second gear is deformed and is less likely to maintain the original shape thereof. Graph (b) implies that the second gear retains the original shape thereof.

According to these results, variation of the second gear may be minimized by employing the reinforcement member of the present invention.

Description has been given above of specific embodiments help an actuator and an electronic apparatus having the same according to the present invention. Those skilled in the art will appreciate that various modifications, additions and substitutions are possible, without departing from the scope and spirit of the invention.

Therefore the scope of the present invention should be defined by the scope of the appended claims and their equivalents, rather than being confined to the embodiments described above.

That is, the embodiments described above should be construed in all aspects as illustrative and not restrictive. The scope of protection sought by the present invention should be determined by the appended claims and their equivalents, and all changes coming within the meaning and equivalency range of the appended claims are intended to be embraced therein.

What is claimed is:

1. An actuator comprising:
a housing unit;
a drive unit installed in the housing unit, the drive unit having a rotating shaft;
a plurality of gears installed in the housing unit and rotated by rotational power of the shaft, the gears being engaged with each other; and
a reinforcement part installed in an inside portion of one of the plurality of gears to create reinforcing force.

2. The actuator according to claim 1, wherein the plurality of gears comprises:
a first gear connected to the shaft arranged along a first axis and configured to rotate;
a second gear configured to rotate about a second axis perpendicular to the first axis in connection with the first gear; and
a third gear configured to rotate about a third axis perpendicular to the second axis in connection with the second gear,
wherein the second gear is a multi-step gear formed stepwise,
wherein the reinforcement part is inserted into an inside of a lower end of the multi-step gear.

3. The actuator according to claim 2, wherein the second gear comprises an upper gear and a lower gear, the lower gear being formed at a lower end of the upper gear and having a greater diameter than the upper gear,
wherein an installation hole is formed at a center of the lower gear,
wherein the reinforcement part is fixedly inserted into the installation hole.

4. The actuator according to claim 3, wherein the reinforcement part is a reinforcement member made of a metallic material and formed in a ring shape.

5. The actuator according to claim 3, wherein the reinforcement part is a reinforcement member having two steps.

6. The actuator according to claim 3, wherein the reinforcement part is a reinforcement member having multiple steps.

7. The actuator according to claim 1, wherein a height of the reinforcement part is covered by a length of the rotation shaft penetrating the gears to rotatably support the gears,
wherein the reinforcement part closely contacts an outer surface of the rotation shaft.

8. The actuator according to claim 1, wherein one region of the reinforcement part is positioned on an axis perpendicular to an axial line of rotation of a counterpart gear part engaged with the reinforcement part.

9. The actuator according to claim 4, wherein a thickness of the reinforcement member in a direction of centripetal force is greater than a thickness of the lower gear.

10. The actuator according to claim 4, wherein the reinforcement member is one of a ball bearing and a sleeve bearing.

11. The actuator according to claim 1, wherein the reinforcement part is installed at the plurality of gears through one of press fitting, welding, caulking and injection molding.

12. The actuator according to claim 2, wherein one end of the first gear is provided with a bearing,
wherein the housing unit is provided with a bearing accommodation portion, the bearing being accommodated in the bearing accommodation portion.

13. The actuator according to claim 12, wherein a bearing cover for covering the bearing is detachably installed at the bearing accommodation portion.

14. An electronic apparatus comprising the actuator according to claim 1.
